(19) United States
(12) Patent Application Publication
(10) Pub. No.: US 2019/0128475 A1
(43) Pub. Date: May 2, 2019

(54) Elastomeric Coating for Ballistic, Blast, Impact and Corrosion Protection of Pressure Vessels

(71) Applicant: The Government of the United States of America, as represented by the Secretary of the Navy, Arlington, VA (US)

(72) Inventors: Charles M. ROLAND, Waldorf, MD (US); Karen Swider LYONS, Alexandria, VA (US); Gary S. BUCKLEY, Lawton, OK (US)

(73) Assignee: The Government of the United States of America, as represented by the Secretary of the Navy, Arlington, VA (US)

(21) Appl. No.: 16/171,283

(22) Filed: Oct. 25, 2018

Related U.S. Application Data
(60) Provisional application No. 62/577,356, filed on Oct. 26, 2017.

(51) Int. Cl. F17C 1/14; F17C 1/16

(52) U.S. Cl. CPC F17C 1/14; F17C 1/16; F17C 2201/0109; F17C 2203/0604; F17C 2203/0607; F17C 2209/232; F17C 2203/0646; F17C 2203/066; F17C 2203/0673; F17C 2203/0675; F17C 2203/0621

(57) ABSTRACT

Shock and/or impact-resistant pressure vessels having elastomeric coatings are provided. The pressure vessels of the invention are significantly lighter than conventional air tanks having the same capacity, while enhancing safety in military and undersea environments. Methods for protecting pressure vessels from ballistic, blast wave, and mechanical impacts, while also providing corrosion protection, are also provided.

### CROSS-REFERENCE TO RELATED APPLICATIONS

This application claims priority to U.S. Provisional Application No. 62/577,356, filed on Oct. 26, 2017, the contents of which are incorporated herein by reference in their entirety.

### TECHNICAL FIELD

The invention relates generally to shock and/or impact-resistant pressure vessels having elastomeric coatings provided thereon. The pressure vessels of the invention are significantly lighter than conventional air tanks having the same capacity, while enhancing safety in military and undersea environments. The invention also provides methods for protecting pressure vessels from ballistic, blast wave, and mechanical impacts, while also providing corrosion protection.

### BACKGROUND OF THE INVENTION

Lightweight compressed gas storage is needed for naval applications ranging from breathing air for divers, to hydrogen storage for fuel cells for unmanned vehicles. Safety is a key feature for compressed gas systems, but standard pressure vessels provide no protection against ballistic threats.

The standard practice has been to add more metal or composite material to the pressure vessel to increase its safety factor, but this may add an unacceptable amount of weight. Type I pressure vessels having all-metal construction (e.g., steel) are widely available, but are heavy. Type II pressure vessels are typically based on a metal tank (e.g., steel or aluminum) having a glass-fiber composite overwrap in the hoop direction, and weigh 30-40% less than Type I vessels. Type III pressure vessels have a metal liner (e.g., aluminum) and a carbon-fiber composite overwrap. Type IV pressure vessels have a plastic liner (e.g., high-density polyethylene) and a carbon fiber or carbon/glass-fiber composite overwrap. In Type III and IV pressure vessels, the composite overwrap provides the structural strength, and they typically weigh 67-75% less than Type I vessels.

Pressure vessels that have a fiber composite overwrap exhibit increased burst resistance, but they are susceptible to fatigue damage from repetitive jostling, with consequent loss of burst strength. They also exhibit poor resistance to ballistic and blast wave impacts that may occur in a naval environment, and are susceptible to corrosion.

Accordingly, there is a need in the art for impact-resistant pressure vessels capable of being used over a range of conditions.

### SUMMARY OF THE INVENTION

The invention described herein, including the various aspects and/or embodiments thereof, meets the unmet needs of the art, as well as others, by providing shock and/or impact-resistant pressure vessels having elastomeric coatings provided thereon. The pressure vessels of the invention are significantly lighter than conventional air tanks having the same capacity, while enhancing safety in military and undersea environments. The invention also provides methods for protecting pressure vessels from ballistic, blast wave, and mechanical impacts, while also providing corrosion protection.

According to one aspect of the invention, an impact-resistant pressure vessel is provided that includes a liner; a fiber-matrix overwrap provided around an exterior of the liner; and an elastomeric coating provided around an exterior of the fiber-matrix overwrap layer.

According to another aspect of the invention, a method is provided for making an impact-resistant pressure vessel, including providing a pressure vessel liner; applying a fiber-matrix overwrap around the outer surface of the pressure vessel liner; and applying an elastomeric coating around the exterior of the fiber-matrix overwrap layer.

Other features and advantages of the present invention will become apparent to those skilled in the art upon examination of the following or upon learning by practice of the invention.

### BRIEF DESCRIPTION OF THE DRAWINGS

FIG. 1 depicts a pressure vessel in accordance with the invention, which includes a liner, a fiber-reinforced composite layer, and elastomeric coating.

FIG. 2 is a close-up of the construction of a wall of a pressure vessel in accordance with the invention, including the tank liner, fiber-reinforced composite layer, and outer elastomer coating layer with optional particles.

FIG. 3 is a close-up of the construction of a wall of a pressure vessel in accordance with the invention, including the tank liner, fiber-reinforced composite layer with optional particles, and outer elastomer coating layer.

FIG. 4A depicts a conventional aluminum pressure vessel having a carbon-fiber composite overwrap, following a ballistic impact. The carbon-fiber composite overwrap has been penetrated.

FIG. 4B depicts an aluminum pressure vessel having a carbon-fiber composite overwrap, and an outer elastomeric coating in accordance with the invention, following a ballistic impact. There is no penetration of the pressure vessel.

### DETAILED DESCRIPTION OF THE INVENTION

The invention described herein, including the various aspects and/or embodiments thereof, meets the unmet needs of the art, as well as others, by providing shock, impact, and projectile resistant pressure vessels having elastomeric coatings provided thereon. The pressure vessels of the invention weigh significantly less than conventional air tanks having the same capacity, while enhancing safety in military and undersea environments. The invention also provides methods for protecting pressure vessels from ballistic, blast wave, and mechanical/projectile impacts, while also providing corrosion protection (particularly important when used in an underwater environment, such as saltwater).

The pressure vessels of the invention permit lower equipment weight as compared to conventional pressure vessels. This beneficially allows more equipment to be carried, and/or for equipment of similar weight to have larger capacity. The pressure vessels of the invention also provide longer endurance and enhanced safety margins, that is, a reduced probability of failure when subjected to conditions in excess of typical operating loads and stresses.

Blast-resistant and bullet-resistant polymer coatings have been developed for steel armor and helmets. The present invention has discovered that by providing advanced elastomeric coatings on pressure vessels, leaking tanks can be rapidly sealed, as the elastomeric coatings of the invention can fill voids created by, for example, ballistic penetrations. The present invention is therefore able to mitigate the effect of ballistic, blast, and mechanical impacts on pressurized vessels. Further, for pressure vessel applications, in which minimizing fuel consumption is often critical, minimization of weight is paramount. The low mass density of the polymeric coatings of the invention as compared to materials such as steel, aluminum, carbon fiber, and ceramics beneficially provides increased range and/or capacity to the pressure vessels without increasing weight.

The coated pressure vessels of the invention may be based on any commercially-available pressure vessels, including Type I, II, III, or IV pressure vessels. The pressure vessels may vary in capacity, type of gas stored, pressure rating, and/or purpose. For example, pressure vessels for fuel cell systems may be capable of storing hydrogen gas at pressures of about 5000 psi (UAV) or 15,000 psi (UUV). Pressure vessels used for diving typically store gas at pressures ranging from about 2500 psi to about 3500 psi, though pressures up to about 4500 psi may be used.

In some aspects of the invention, the coated pressure vessels of the invention are preferably based on Type II, III, or IV pressure vessels, which include a fiber-reinforced composite overwrap. The elastomeric coatings of the invention may also be applied to other pressure vessels not having a fiber-reinforced composite overwrap, including, but not limited to, Type I pressure vessels.

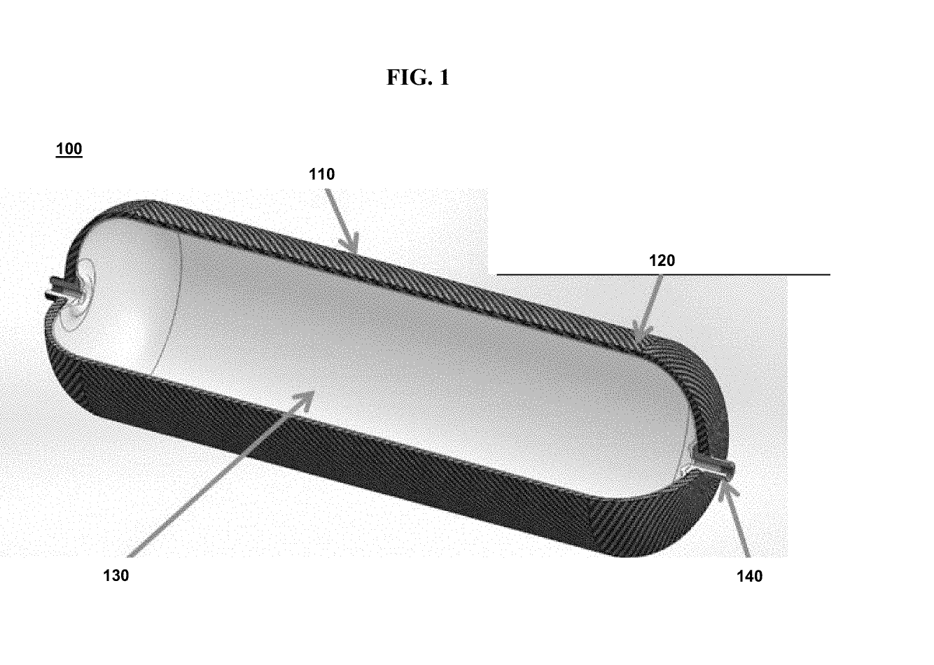

An exemplary pressure vessel in accordance with the invention is shown in FIG. 1. The pressure vessel 100 includes a lining 110, which may be formed from steel, aluminum, or plastic (e.g., polyethylene, such as high-density polyethylene or low-density polyethylene, polyamide, etc.), and is preferably formed from aluminum or plastic in order to minimize weight. The pressure vessels of the invention may optionally use a fiber-reinforced composite overwrap 120 to provide the structural strength required to store gas at the pressure for which the vessel is rated.

Regardless of the construction of the pressure vessel, the coated pressure vessels 100 have an elastomeric polymer coating 130 applied to their outside surface. The polymer coating may be applied using any technique suited to the selected polymer, including dipping, spraying, painting, or immersion. The polymers may be selected from elastomers including polyurea, atactic polypropylene, polyvinylethylene, polyisobutylene or butyl rubber (polyisobutylene having some unsaturation to enable sulfur curing), and nitrile rubber. Preferably, the polymer coating is selected from polyurea, butyl rubber, atactic polypropylene, and combinations thereof. The polymers may be selected, and optionally modified, based on their resistance to water penetration, particularly by seawater.

The polymers used as coatings for the pressure vessels in accordance with the invention preferably exhibit sufficient hardness to permit them to provide resistance to ballistic and non-ballistic impacts, and also exhibit elasticity that permits them to return to their original shape after a ballistic or non-ballistic impact. In some aspects of the invention, hardness ranges from Shore A=50 to Shore D=50 are preferred. In some aspects of the invention, the pressure vessels are formed using an outer polymer layer that comprises polyurea, where the ratio of isocyanate to diamine may be adjusted to form polyurea having about 20-50 vol. % hard domains, preferably 25-40 vol. % hard domains, more preferably about 29 vol. % hard domains.

The elastomeric polymer coating may be applied to substantially the entire surface of the pressure vessel in order to mitigate corrosion damage as well as impact damage. The elastomeric polymer coating may be applied using any technique suited to the selected polymer, including dipping, spraying, painting, and immersion. The polymer coating is preferably applied to the outside of the tank to a thickness of from about 1 to about 5 mm, more preferably from about 2 to about 4 mm. It has been discovered in accordance with the invention that a coating ranging from about 2 to about 4 mm is sufficiently thick to permit the elastomeric coating to seal leaks in the underlying pressure vessel. Without wishing to be bound by theory, it is believed that this occurs because the polymers exhibit sufficient elasticity to return to their original shape, or substantially the same shape, following an impact.

The elastomeric polymer coatings of the invention, when provided on pressure vessels used to store air, hydrogen, and other gases under high pressure, aid in (i) mitigating damage from ballistic or blast assault to maintain resistance to bursting; (ii) dampening effects of mechanical impact, bumping, etc., thereby preventing fracture or fatigue failure; and (iii) slowing ingress of external fluids (e.g., seawater) to reduce corrosion of the underlying pressure vessel.

The elastomeric polymer coatings of the invention may optionally include particles therein. The particles, when provided, enhance blast and impact response, but minimally affect ballistic or projectile resistance.

When provided in the elastomeric polymer coatings of the invention, the particles improve the level of resistance to blast and shock waves. Particle compositions that may be used in accordance with the invention include ceramic materials such as those used in armor materials (i.e., one or more of boron carbide, silicon carbide, aluminum oxide, titanium diboride, silicon nitride, aluminum nitride, and tungsten carbide) provided in the form of hollow or solid particles. Particle compositions may also include glass or plastic/resin (i.e., one or more of polycarbonate, polyethylene, and acrylic) as hollow or solid spheres. For example, in some aspects of the invention, lower-cost aluminum oxide hollow ceramic particles are used in place of silicon carbide particles. In other aspects of the invention, combinations of one or more of these particle and sphere materials may be used to achieve the desired level of protection from impacts. The particles incorporated into the elastomeric coating may be solid or hollow, as dictated by considerations of weight and protection level, and may encompass any shape, including round or ball-like (including, but not limited to, perfect spheres), as well as irregular shapes or fragments such as may be obtained by fragmenting larger pieces of the material from which the particles were formed

The particles can have an average size of from about 0.25 mm up to the thickness of the pressure vessel elastomeric polymer coating layer (which may be up to about 5 mm thick), preferably from about 0.5 mm to about 2 mm, and most preferably are about 1 mm in diameter.

Separation between the particles, when provided, can be from zero (touching) to a maximum distance equal to the average radius of the particles being used, with the value within this range selected based on minimum strength requirements and weight/density goals. The advantages of using discrete particles include: (i) the particles induce obliquity in the path of a projectile; (ii) the particles provide spatial dispersion of the pressure waves from an incoming projectile; (iii) the particles provide a reduction in the areal density of the tank; (iv) the particles can cause fracture or abrasion of the projectile by impact on the particles (even upon fracture of the particles themselves, since encapsulation by the surrounding elastomeric polymer maintains the comminuted material in the path of the incoming projectile); and (v) fracture of the particles provides an energy dissipation mechanism that attenuates incoming pressure waves.

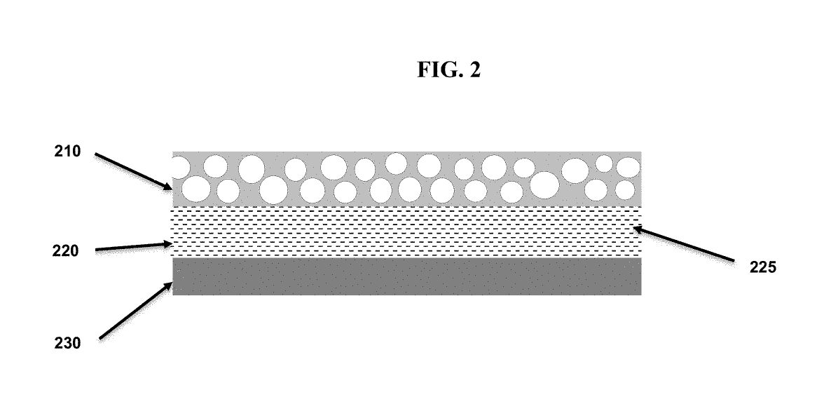

One pressure vessel wall configuration is shown in FIG. 2. The pressure vessel has a liner 210 that is covered on its outer surface with a fiber-reinforced composite material 220. The elastomeric coating 230 is provided on the outer surface of the fiber-reinforced composite material, such that the fiber-reinforced composite layer 220 is between the liner 210 and the elastomeric coating 230. In accordance with this aspect of the invention, the pressure vessel may optionally be stiffened by incorporating particles into the elastomeric polymer used to coat the pressure vessel. These particles 225 enhance the contribution of the elastomeric coating 230 to ballistic performance.

Preferably, the elastomeric coating of the invention is applied to a pressure tank having a fiber-composite overwrap. Commercially-available carbon-fiber or glass-fiber wrapped Type II, III, or IV pressure vessels may be obtained, and then coated with the elastomeric coatings in accordance with the invention. However, in some aspects of the invention, pressure vessels are wrapped with a fiber-matrix composite material that contains particles therein. The tank used to form these pressure vessels may be a fiber-reinforced, composite-wrapped aluminum tank or a fiber-reinforced, composite-wrapped plastic tank. The fiber-composite overwrap may be formed by using any commercially available fiber and matrix composite system and providing the particles of the invention in the matrix material.

The invention is not limited to any particular fiber-reinforced composite. Fibers may include, but are not limited to, carbon, aramid, glass, boron, high-modulus polyethylene (PE), poly p-phenylene-2,6-benzobisoxazole (PBO), and combinations thereof Matrix materials may include, but are not limited to, plastics, ceramics, metals, and combinations thereof. The fiber-reinforced composite materials used in accordance of the invention may beneficially utilize high strain rate sensitive polymers. Polymer matrices are preferred in some aspects of the invention, and may be selected from thermoset resins and thermoplastic resins. Thermoset resins may include polyesters, optionally incorporating additional reactive monomers (e.g., styrene); vinyl esters; epoxies; phenolics; cyanate esters; bismaleimides; benzoxzines; and polyimides. The thermoset resins may be cured using any acceptable catalyst or hardener, as appropriate for the selected resin. Thermoplastic resins may include polyethylene (PE), polyethylene terephthalate (PET), polybutylene terephthalate (PBT), polycarbonate (PC), acrylonitrile butadiene styrene (ABS), polyamide (PA or nylon) and polypropylene (PP), polyetheretherketone (PEEK), polyetherketone (PEK), polyamide-imide (PAI), polyarylsulfone (PAS), polyetherimide (PEI), polyethersulfone (PES), polyphenylene sulfide (PPS) and liquid crystal polymer (LCP).

When provided in the fiber-composite overwrap of the invention, the particles improve the level of resistance to blast and shock waves. Particle compositions that may be used in accordance with the invention include ceramic materials such as those used in armor materials (i.e., one or more of boron carbide, silicon carbide, aluminum oxide, titanium diboride, silicon nitride, aluminum nitride, and tungsten carbide) provided in the form of hollow or solid particles. Particle compositions may also include glass or plastic/resin (i.e., one or more of polycarbonate, polyethylene, and acrylic) as hollow or solid spheres. For example, in some aspects of the invention, lower-cost aluminum oxide hollow ceramic particles are used in place of silicon carbide particles. In other aspects of the invention, combinations of one or more of these particle and sphere materials may be used to achieve the desired level of protection from impacts. The particles incorporated into the fiber-matrix composite may be solid or hollow, as dictated by considerations of weight and protection level, and may encompass any shape, including round or ball-like (including, but not limited to, perfect spheres), as well as irregular shapes or fragments such as may be obtained by fragmenting larger pieces of the material from which the particles were formed.

The particles can have an average size of from about 0.25 mm up to the thickness of the fiber-composite pressure vessel wrap layer, preferably from about 0.5 mm to about 2 mm, and most preferably are about 1 mm in diameter. The thickness of the fiber-composite pressure vessel overwrap will depend on the pressure capacity required, in accord with established design principles. For example, the thickness of the fiber-composite overwrap may range from about 0.01″ to about 1″ (about 0.254 mm to about 25.4 mm), preferably from about 0.05″ to about 0.5″ (about 1.27 mm to about 12.7 mm), and more preferably from about 0.1″ to about 0.25″ (about 2.54 mm to about 6.35 mm).

In one embodiment, the fiber-reinforced composite layer is formed by encapsulating silicon carbide hollow spheres of about 1 mm in diameter within a carbon fiber matrix composite by blending the spheres into the matrix material prior to impregnating the carbon fibers and curing the matrix. In another embodiment, the elastomeric polymer coating layer is formed by encapsulating silicon carbide hollow spheres of about 1 mm in diameter within a polyurea coating material prior to applying it to the exterior surface of the pressure vessel.

Separation between the particles, when provided, can be from zero (touching) to a maximum distance equal to the average radius of the particles being used, with the value within this range selected based on minimum strength requirements and weight/density goals. The advantages of using discrete particles include: (i) the particles induce obliquity in the path of a projectile; (ii) the particles provide spatial dispersion of the pressure waves from an incoming projectile; (iii) the particles provide a reduction in the areal density of the tank; (iv) the particles can cause fracture or abrasion of the projectile by impact on the particles (even upon fracture of the particles themselves, since encapsulation by the surrounding fiber matrix composite maintains the comminuted material in the path of the incoming projectile); and (v) fracture of the particles provides an energy dissipation mechanism that attenuates incoming pressure waves.

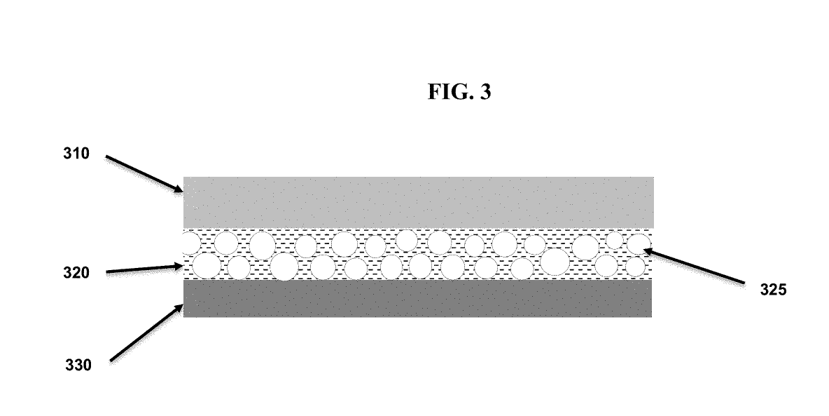

Another pressure vessel wall configuration is shown in FIG. 3. The pressure vessel has a liner 310 that is covered on its outer surface with a fiber-reinforced composite material 320. The fiber-reinforced composite material may optionally incorporate particles 325 therein. The elastomeric coating 330 is provided on the outer surface of the fiber-reinforced composite material, such that the fiber-reinforced composite layer 320 is between the liner 310 and the elastomeric coating 330. In accordance with this aspect of the invention, the pressure vessel may optionally incorporate the particles into the resin used to impregnate the fiber composite. These particles 325 enhance the contribution of the fiber-reinforced composite wrap 320 to ballistic performance.

The invention encompasses using particles in both the fiber-reinforced composite material and the elastomeric coating. The invention further encompasses pressure vessels in which neither the fiber-reinforced composite material nor the elastomeric polymer coating have particles provided therein.

The incorporation of the particles into either or both of the fiber-reinforced composite layer and elastomeric polymer coating layer results in a tank that provides further increased durability when subjected to ballistic and blast-wave impacts. For example, the presence of the particles may result in lower density, higher specific strength (i.e., strength divided by density), a lower coefficient of thermal expansion, and in some cases, radar or sonar transparency.

### EXAMPLES

The invention will no be particularly described by way of example. However, it will be apparent to one skilled in the art that the specific details are not required in order to practice the invention. The following descriptions of specific embodiments of the present invention are presented for purposes of illustration and description. They are not intended to be exhaustive of or to limit the invention to the precise forms disclosed. Many modifications and variations are possible in view of the above teachings. The embodiments are shown acid described in order to best explain the principles of the invention and its practical applications, to thereby enable others skilled in the art to best utilize the invention and various embodiments with various modifications as are suited to the particular use contemplated.

### Example 1

A conceptual design of a rubber-coated diving tank in accordance with the invention is shown in FIG. 1.

Standard Twin 80 aluminum tanks have a diameter of about 7.25 inches, and an outer length of about 2.5 to about 26 inches. Standard service pressures are from about 3000 to about 3300 PSI, and the storage volume at these pressures is about 77.4 cubic feet. The cylinder dry weights range from about 24.4 to about 35.7 lbs.

Standard Twin 80 steel tanks have a diameter of about 7.25 inches, and an outer length of about 20 inches. Standard service pressures are from about 3100 to about 3500 PSI, and the storage volume at these pressures are about 80 to about 81 cubic feet. The cylinder dry weights range from about 29.9 to about 32.5 lbs.

Inventive pressure vessels based on Type III construction having an aluminum liner, a carbon fiber overwrap, and an elastomeric outer coating were prepared to the approximate dimensions of Twin 80 tanks. The inventive pressure vessels had a diameter of about 7.25 inches, a length of about 26.1 inches, and a service pressure of 3000 or 5000 PSI. The 3000 PSI pressure vessel had a storage volume of 93.9 cubic feet and an internal volume of about 13.4 L, while the 5000 PSI pressure vessel had a storage volume of 133.7 cubic feet and an internal volume of about 12.8 L. The 3000 PSI pressure vessel had a dry weight of 9.0 lb, and the 5000 PSI pressure vessel had a dry weight of 10.8 lbs. These calculations were made using a 3× safety factor.

An analysis of the dry weight of the inventive pressure vessels versus the dry weight of conventional “Twin 80”-type aluminum and steel vessels used by Navy divers reveals that the pressure vessels having the elastomeric polymer coatings of the invention provide approximately a ⅔ weight savings(i.e., a 66% weight reduction). This significant weight reduction allows divers to carry more tools, and provides greater ease of handling of the tanks while on deck. Alternatively,the pressure rating of the inventive tanks could be increased to even higher pressures (e.g., 7500 psi), with some additional weight of the tank, but still far below the weight of a conventional Twin 80 tank.

In addition, the construction of the inventive pressure vessels provides them with less buoyancy in salt water as compared to conventional Twin 80-type aluminum and steel vessels.

The inventive pressure vessels constructed to the above specifications had a full buoyancy in salt water of −16.2 lb (3000 PSI pressure vessel) and −13.9 lb (5000 PSI pressure vessel). This is compared to a full buoyancy in salt water of −1.4 to −5.9 lb for Twin 80-type aluminum pressure vessels, and −9.0 to −13.2 lb for Twin 80-type steel pressure vessels.

The inventive pressure vessels constructed to the above specifications had an empty buoyancy in salt water of −26.3 lb (3000 PSI pressure vessel) and −24.5 lb (5000 PSI pressure vessel). This is compared to an empty buoyancy in salt water of −1.4 to +4.2 lb for Twin 80-type aluminum pressure vessels, and −3.0 to −7.2 lb for Twin 80-type steel pressure vessels.

The data for several commercially available Twin 80-type aluminum and steel pressure vessels is presented in Table 1.

TABLE 1

| | | | | Storage | | Salt | Salt |
|---|---|---|---|---|---|---|---|
| | | | Service | Volume | Cylinder | Water | Water |
| | DIAMETER | O.A.L | pressure | @ Service | Dry | Boyancy | Boyancy |
| BRAND AND DESIGNATION | INCH | INCH | PSI | Pressure | Weight | Full | Empty |
| Catalina AL 80 | 7.25 | 25.9 | 3000 | 77.4 FT [symbol] | 31.3 lb | −1.6 lb | +2.8 lb |
| Catalina ALC 80 | 7.25 | 25.1 | 3300 | 77.4 FT [symbol] | 34.4 | −5.9 lb | −1.4 lb |
| LuxferAL 80 | 7.3 | 25.8 | 3000 | 77.4 FT [symbol] | 24.4 lb | −1.7 lb | +4.2 lb |
| Sherwood AL 80 | 7.25 | 25.9 | 3000 | 77.4 FT [symbol] | 35.7 | −1.4 lb | +3.4 lb |
| Worthinton Steel X Series X7-80 | 7.25 | 19.8 | 3442 | 81.0 FT [symbol] | 29.9 | −9.0 lb | −3.0 lb |
| Faber80 (steel) | 7.25 | 19.88 | 3180 | 80 | 32.5 | −13.2 lb | −7.22 lb |

[symbol]

indicates data missing or illegible when filed

### Example 2

Testing of pressure vessels of the invention has been carried out using commercially-available aluminum tanks having carbon-fiber composite layers, which are rated for 10,000 PSI.

Control tanks (“uncoated”) were not coated with the elastomeric outer layer of the invention. Inventive tanks (“4 mm”) were coated with 1 lb of polyurea, which was applied to the outside surface of the 10,000 PSI pressure vessel by painting. The coating was applied evenly to a thickness of about 4 mm so as not to change the center of gravity of the tank.

Burst strength retention for the uncoated tank and the tank having a 4 mm thick elastomeric coating were compared by firing a 400 g tungsten carbide rod at the tanks at a velocity of 20 m/s.

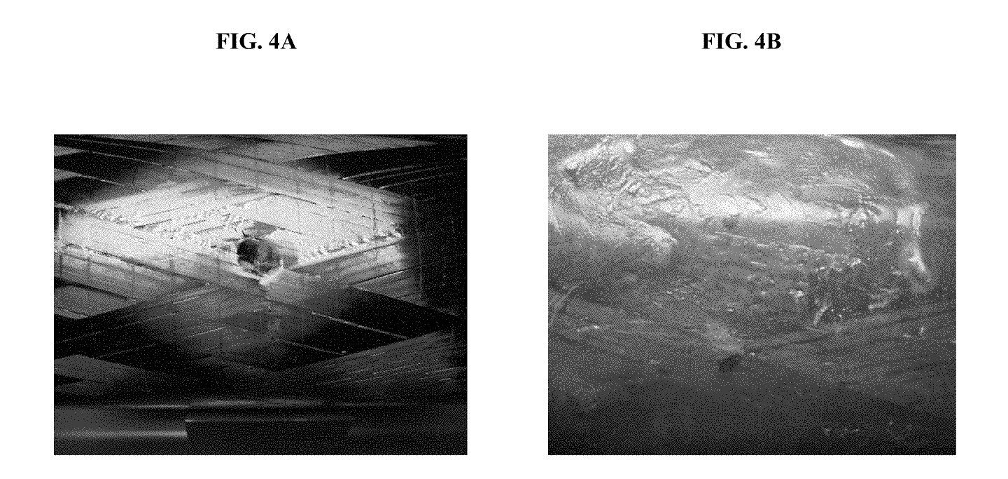

Results of the ballistic impacts are shown in Table 2, and in FIGS. 4A and 4B. The pressure vessels are shown after being subjected to the ballistic impact, but before the burst strength of the impacted pressure vessel was measured. The pressure vessel in FIG. 4A was not coated with the elastomeric polymer coating of the invention. The pressure vessel in FIG. 4B was coated with the elastomeric polymer coating of the invention. The elastomeric coating did not include the optional particles of the invention.

The uncoated tank, after being subjected to the ballistic impact, burst when pressurized to 3990±220 PSI. The inventive tank coated with 4 mm of polyurea, after being subjected to the ballistic impact, was pressurized to 9130±540 PSI before it burst. This result demonstrates that the coatings of the invention beneficially allow pressure vessels to retain most of their capacity even after a ballistic impact.

TABLE 2

| | Burst Pressure |
|---|---|
| uncoated tank | 3990 ± 220 PSI |
| 4 mm polyurea | 9130 ± 540 PSI |

### Example 3

Laboratory tests demonstrated the efficacy of the coatings in retarding corrosion of aluminum immersed in seawater.

Ten 6″×1″×¼″ aluminum coupons from McMaster-Carr (part number 8975K596) were split into two groups of five. One group was treated with polyurea (4 mm thick coating), and the other group was not treated.

Forty (40) liters of simulated seawater were created in a 15-gallon aquarium using Instant Ocean. The final density of the saltwater was 1.029 g/mL. The coated and uncoated aluminum coupons were suspended in the salt water for approximately one month of exposure.

Accelerated corrosion was observed for uncoated aluminum coupons. This degradation included bubble formation, discoloration below the water line, development of black streaks, and the early stages of pitting. Continued exposure would result in pitting and more serious corrosion.

The aluminum coupons having the polyurea coating exhibited significantly decreased levels of degradation as compared to the uncoated aluminum coupons. The elastomer-coated aluminum coupons only exhibited some discoloration. It is believed that the discoloration occurred because water diffused through the polyurea coating and eventually made contact with the aluminum. It is believed that this discoloration could be avoided by the use of a more hydrophobic coating (e.g., butyl rubber or atactic polypropylene)

It will, of course, be appreciated that the above description has been given by way of example only and that modifications in detail may be made within the scope of the present invention.

Throughout this application, various patents and publications have been cited. The disclosures of these patents and publications in their entireties are hereby incorporated by reference into this application, in order to more fully describe the state of the art to which this invention pertains.

The invention is capable of modification, alteration, and equivalents in form and function, as will occur to those ordinarily skilled in the pertinent arts having the benefit of this disclosure. While the present invention has been described with respect to what are presently considered the preferred embodiments, the invention is not so limited. To the contrary, the invention is intended to cover various modifications and equivalent arrangements included within the spirit and scope of the description provided above.

What is claimed:

1. An impact-resistant pressure vessel, comprising
a liner;
a fiber-reinforced composite overwrap provided around an exterior surface of the liner; and
an elastomeric coating provided around an exterior surface of the fiber-reinforced composite overwrap.

2. The impact-resistant pressure vessel of claim 1, wherein the liner is a material selected from the group consisting of aluminum and plastic.

3. The impact-resistant pressure vessel of claim 1, wherein the fiber-reinforced composite overwrap comprises a fiber selected from the group consisting of glass fiber, carbon fiber, aramid fiber, boron fiber, high-modulus polyethylene, poly-p-phenylene-2,6-benzobisoxazole, and combinations thereof.

4. The impact-resistant pressure vessel of claim 1, wherein the fiber-reinforced composite overwrap comprises a matrix material selected from the group consisting of a thermoset resin or a thermoplastic resin.

5. The impact-resistant pressure vessel of claim 1, wherein the elastomeric coating comprises a polymer selected from the group consisting of polyurea, polyisobutylene or butyl rubber, thermoplastic atactic polypropylene, and combinations thereof.

6. The impact-resistant pressure vessel of claim 1, wherein the fiber-reinforced composite overwrap comprises particles embedded in the matrix.

7. The impact-resistant pressure vessel of claim 1, wherein the elastomeric coating comprises particles embedded therein.

8. The impact-resistant pressure vessel of claim 7, wherein the particles comprise materials selected from the group consisting of ceramics, glasses, plastics, and combinations thereof.

9. The impact-resistant pressure vessel of claim 8, wherein the ceramics are selected from the group consisting of boron carbide, aluminum oxide, silicon carbide, titanium diboride, silicon nitride, aluminum nitride, tungsten carbide, and combinations thereof.

10. The impact-resistant pressure vessel of claim 7, wherein the particles are solid.

11. The impact-resistant pressure vessel of claim 7, wherein the particles comprise hollow spheres.

12. A method for making an impact-resistant pressure vessel, comprising:
providing a pressure vessel liner;
applying a fiber-reinforced composite overwrap around the outer surface of the pressure vessel liner; and
applying an elastomeric coating around the exterior of the fiber-reinforced composite overwrap.

13. The method of claim 12, wherein the liner comprises a material selected from the group consisting of aluminum and plastic.

14. The method of claim 12, wherein the fiber-reinforced composite overwrap comprises a fiber selected from the group consisting of glass fiber, carbon fiber, aramid fiber, boron fiber, high-modulus polyethylene, poly-p-phenylene-2,6-benzobisoxazole, and combinations thereof.

15. The method of claim 12, wherein the fiber-reinforced composite overwrap is applied using a thermoset resin or a thermoplastic resin.

16. The method of claim 12, wherein the elastomeric coating comprises a polymer selected from the group consisting of polyurea, polyisobutylene, thermoplastic atactic polypropylene, and combinations thereof.

17. The method of claim 12, wherein the fiber-reinforced composite overwrap comprises particles embedded in the matrix.

18. The method of claim 12, wherein the elastomeric coating comprises particles embedded therein.

19. The method of claim 16, wherein the particles comprise materials selected from the group consisting of ceramics, glasses, plastics, and combinations thereof.

20. The method of claim 17, wherein the ceramics are selected from the group consisting of boron carbide, aluminum oxide, silicon carbide, titanium diboride, silicon nitride, aluminum nitride, tungsten carbide, and combinations thereof.
